(19) United States
(12) Patent Application Publication
(10) Pub. No.: US 2006/0009987 A1
(43) Pub. Date: Jan. 12, 2006

(54) Distributed scheduling

(76) Inventor: Fang Wang, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/530,279

(22) PCT Filed: Oct. 8, 2003
(86) PCT No.: PCT/GB03/04380

§ 371 Date: Apr. 5, 2005

(30) Foreign Application Priority Data
Oct. 9, 2002 (GB) 0223464.9

(51) Int. Cl. G06Q 99/00

(52) U.S. Cl. 705/1; 705/8; 705/9

(57) ABSTRACT

The invention concerns the scheduling of activities that involve a plurality of distributed resources, such as scheduling meetings that involve a plurality of attendees or scheduling processor activity, where the processors are arranged to control devices and/or other processors. In each of these examples, the resources communicate with one another to identify times at which the actions and/or activities can be scheduled to occur. In the context of scheduling meetings, the invention is embodied in a method of selecting a time for an event, where the event involves a plurality of resources. A process is performed in respect of each resource. The process involves identifying a slot time corresponding to a time at which the resource is available and creating a software component corresponding to the identified slot. The software component comprises communicating means arranged to communicate with other like software components, and storage arranged to store data in respect of the resource corresponding to the software component and data in respect of the identified slot time. Each software component so created communicates with another like software component in order to identify a time for the event that satisfies a predetermined criterion. In the context of scheduling processing events, the invention is embodied in a method of distributing a plurality of tasks between a plurality of resources. Here, a process is performed in respect of each resource. This process comprises identifying a processing capability of the resource and creating a software component corresponding to the identified capability. The software component comprises communicating means arranged to communicate with other like software components, and storage arranged to store data (including the identified capability) in respect of the resource corresponding to the software component. Each software component so created communicates with another like software component in order to identify distribution of tasks that satisfies a predetermined criterion.

The present invention relates to scheduling of events that involve a plurality of resources, and has particular application in scheduling of meetings and tasks.

Distributed scheduling involves scheduling actions and/or activities of resources, which are distributed with respect to one another. Examples of distributed scheduling include scheduling meetings that involve a plurality of attendees; scheduling shift work involving a plurality of workers; and scheduling processor activity, where the processors are arranged to control devices and/or other processors. In each of these examples, the resources communicate with one another to identify times at which the actions and/or activities can be scheduled to occur. Quite often, each resource (respectively attendee, worker and processor) is represented by an agent. An agent, for the purposes of this specification, is a computer program, which is operable to carry out certain processes. In the context of distributed scheduling, an agent manages the scheduling negotiations on behalf of its respective resource.

Early work on automatic meeting scheduling has been carried out by Jennings, N. R. and Jackson, A. J, and described in “Agent based meeting scheduling: A design and implementation” (IEE Electronics Letters Journal, (1995) 31(5): 350-352); by Sen, S. and Durfee, E. H. (1994), as described in “On the design of an adaptive meeting scheduler” (Proceedings of the Tenth IEEE Conference on Artificial Intelligence Applications, pages 40-46); and by Sen, S. (1997), as described in “An Automated Distributed Meeting Scheduler” (IEEE Expert, 12(4):41-45). These early workers used contract net or the like for inter-agent negotiation protocols (Smith, R. G. (1980) “The contract net protocol: High-level communication and control in a distributed problem solver” IEEE Transactions on Computers, C-29(12):1104-1113).

Several patents and patent applications describe methods for performing distributed scheduling, among them is U.S. Pat. No. 5,781,731, which describes a system used for scheduling presentations at conferences. In U.S. Pat. No. 5,781,731, potential attendees specify a preferred time for a meeting using fuzzy logic in the form “around X”. These time requests are sent, from each of the delegates, to a processor, which attempts to identify a time period that satisfies all of the delegates' preferences. When a solution has been reached, the processor schedules the meeting within the time period, notifying each attendee thereof.

International patent application number PCT/GB99/03605, publication number WO00/26828 (Applicant's reference A25707) describes a system for scheduling meetings, where both the time and duration of the meeting are specified using fuzzy logic. The host agent sends out an invitation to meeting attendees to attend an “early morning” meeting, whereupon the attendees submit a fuzzy function for “early morning”. This function embeds their preferences for particular times in the early morning (e.g. 8 am: 0.2; 9 am: 0.7; 10 am: 0.9). The host agent then processes the individual fuzzy functions, in an attempt to find a time that satisfies all of the attendees' preferences.

In the above-described work, there is a central host agent, which communicates with all the attendee agents and is responsible for coordinating the search for a feasible schedule. Having a single control point of scheduling means that the host agent can become overloaded and, in the event that the host agent fails, the whole scheduling process stops. In addition the computation cost can increase rapidly with problem size and complexity.

The central control problem has been addressed by Garrido-Luna, L. and Sycara, K. P. (1996), as described in “Towards a totally distributed meeting scheduling system” (Lecture Notes in Computer Science, 1137:85-97) and by Sycara, K. and Liu, J. S. (1994), as described in “Distributed Meeting Scheduling” (Proceedings of the Sixteenth Annual Conference of the Cognitive Society). Their work splits the co-ordination into a plurality of negotiation iterations, and identifies an agent having the fewest available time intervals as the coordinator for each iteration. This means that that the coordination work is distributed between several user agents. Nevertheless, for each iteration, one of the user agents is required to undertake the coordination work. Moreover, the availability information of every user is needed for selecting a suitable coordinator, which means that user privacy cannot be easily protected.

The Calendar facility of Microsoft's Outlook™ enables a user (proposer) to propose a meeting time to one or more other users (attendees). The proposer's diary application checks the calendar of the attendee(s), and, if the attendee appears to be free at the proposed time, sends a message to the attendee, asking them to accept or decline the invitation. The problem with this is that each proposal relates to a single, clearly defined meeting time, to which the attendee is required to respond. Thus if the proposed time is not convenient, the proposer has to suggest an alternative time; if there are several attendees, the chances of identifying a convenient time are small, and the amount of interaction with the users becomes prohibitively large.

According to a first aspect of the invention there is provided a method of scheduling an event, the event involving a plurality of resources, the method comprising
performing a process in respect of each resource, the process comprising
   identifying a slot time corresponding to a time at which the resource is available; and
   creating a software component corresponding to the identified slot time;
   wherein the software component comprises communicating means arranged to communicate with other like software components, and storage arranged to store data in respect of the resource corresponding to the software component and data in respect of the identified slot time;
   and wherein each software component so created communicates with another like software component in order to identify a time for the event that satisfies a predetermined criterion.

In the following description a slot time is alternatively referred to as a slot, and a software component is referred to as a slot agent.

Thus, in comparison with prior art distributed scheduling systems, software components according to a first embodiment, which represent meeting participants, do not play a passive role in the scheduling process; rather, all software components—whether associated with invitees or host—interact with each other as equal parties. This means that there is no single point of failure or processing bottleneck, because operation of the software components is not coordinated by a centralised controller.

The software components, or slot agents, are not involved in complex negotiations designed to identify a single time that is convenient for all attendees; rather, they are only concerned with identifying another software component corresponding to a slot. This means that the invention is scalable. Preferably, the first embodiment identifies a plurality of slots that are convenient for at least some attendees, meaning that there are “fall back” positions that can be utilised in the event that one of the slots subsequently becomes invalid.

Since the process of identifying slots is handled exclusively by these software components, the diary management application is free to attend to other schedule-related tasks, which is advantageous because the act of scheduling a meeting is only one aspect of time management.

Preferably software components relating to the same slot combine to form a single software component. Conveniently, such combining of software components involves passing the invitee details corresponding to one of the software components to the other software component, and deleting the software components whose invitee details were passed; this retained software component thus records invitee details relating to itself and to the deleted slot agent.

Another aspect of the first embodiment relates to privacy. Preferably only one slot agent created at a time, which means that the availability of a meeting participant is only checked when necessary (i.e. if a previously created slot is not convenient for the attendees).

Conveniently the data passed by a slot agent, when combining with another corresponding to the same slot, can include the preference of an invitee to attend the meeting at the time of this slot.

This preference can be used to calculate an overall group preference that indicates the degree to which the invitees, as a group, want to attend a meeting at the time of a slot. In the event that a plurality of slots is identified, the group preference can be used to rank the identified slots. If the group preference falls below a specified threshold, the slot is discarded.

Although, in the first embodiment, the software components negotiate in respect of the time of a meeting, the software components could alternatively, or additionally, negotiate in respect of the location, duration etc. of the meeting. In this case, instead of identifying a slot time corresponding to a time at which the resource is available, the process could involve identifying a slot location corresponding to a place at which the resource is available, or identifying a slot duration corresponding to a duration for which the resource is available. In these other arrangements, the storage of the created software component will store data in respect of, respectively, location and slot duration. Thus in the specification, the phrase “slot time” means event parameters that are the subject of negotiations between the plurality of resources.

According to a further aspect of the invention there is provided a method according to claim 19, which results in inter-software component negotiation relating to allocation of resources to tasks.

Some embodiments of the invention will now be described, by way of example, with reference to the accompanying drawings, in which:

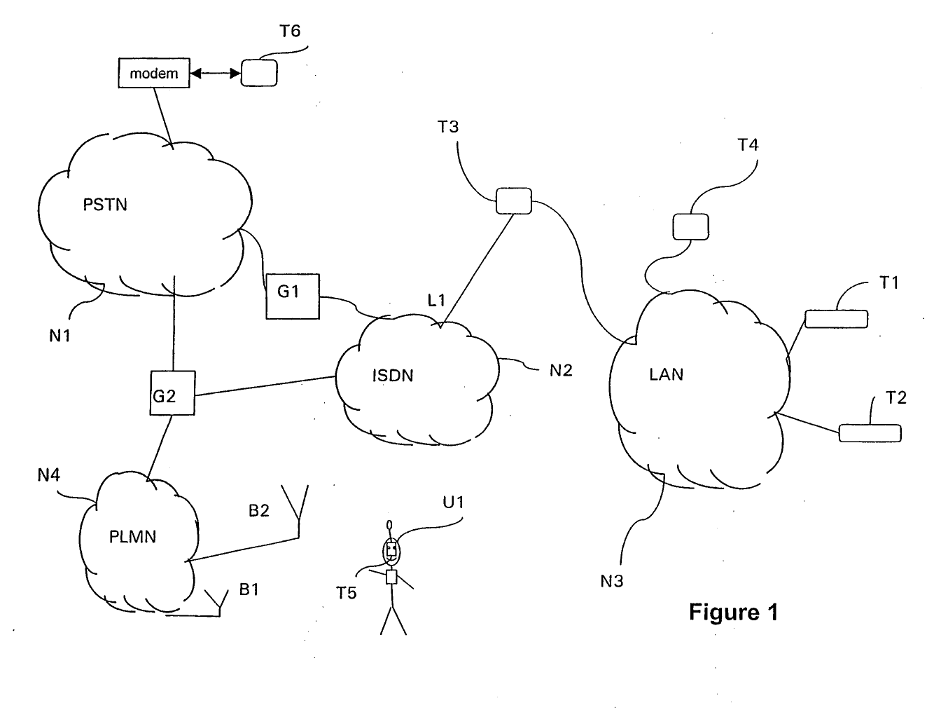

FIG. 1 is a schematic block diagram of the physical environment within which apparatus for scheduling tasks according to the invention operate;

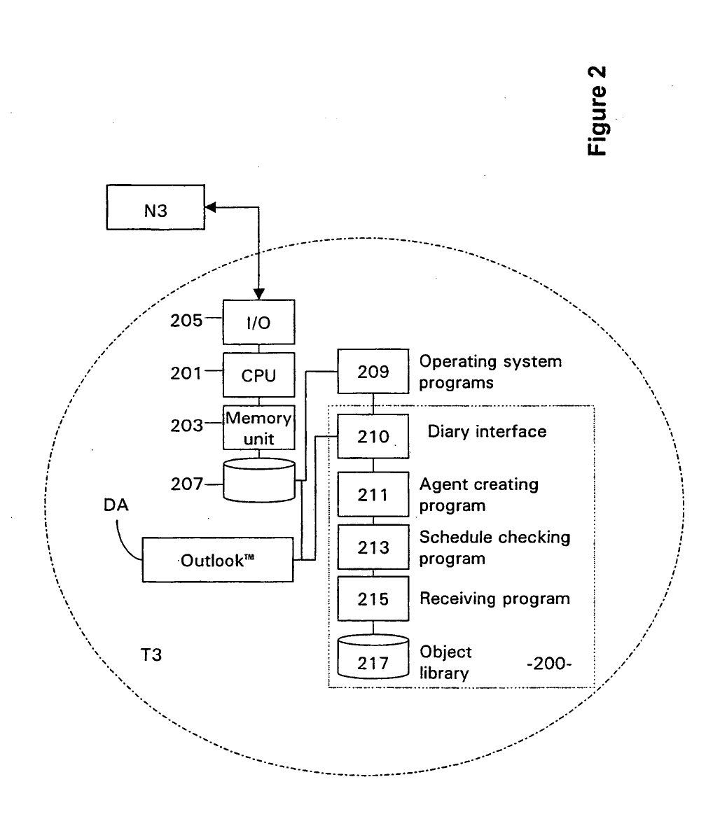

FIG. 2 is a schematic diagram showing an embodiment of apparatus for scheduling tasks;

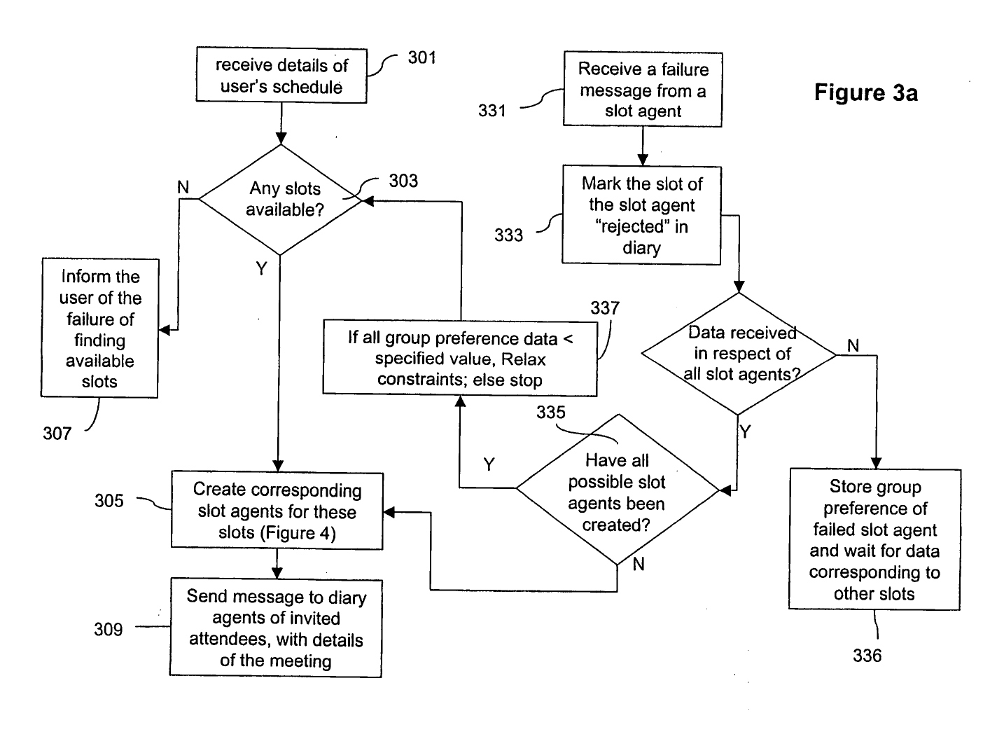

FIG. 3a is a flow diagram showing steps involved in creating slot agents;

FIG. 3b is a flow diagram showing actions carried out by the apparatus of FIG. 2 in response to receipt of an availability message from a slot agent created according to FIG. 3a;

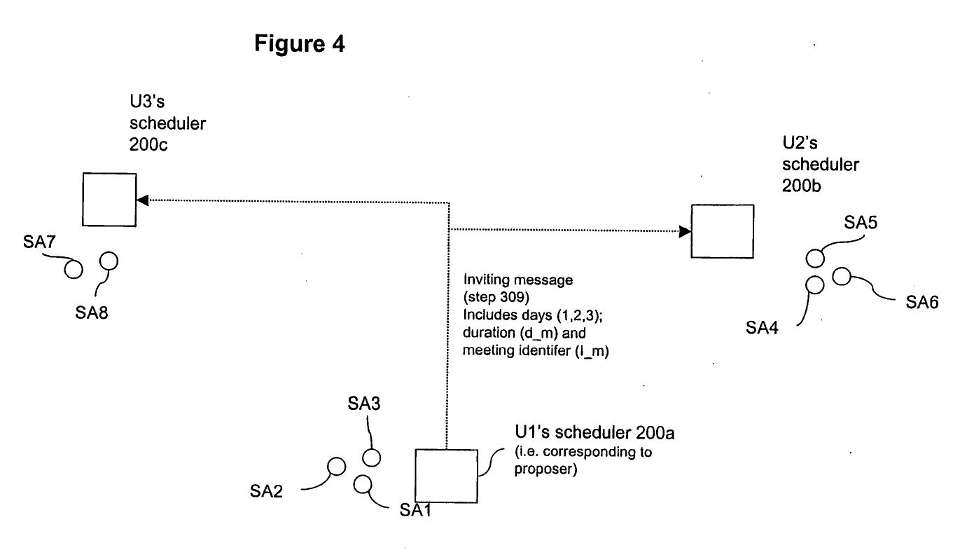

FIG. 4 is a schematic flow diagram showing slot agents created in accordance with the steps of FIG. 3a;

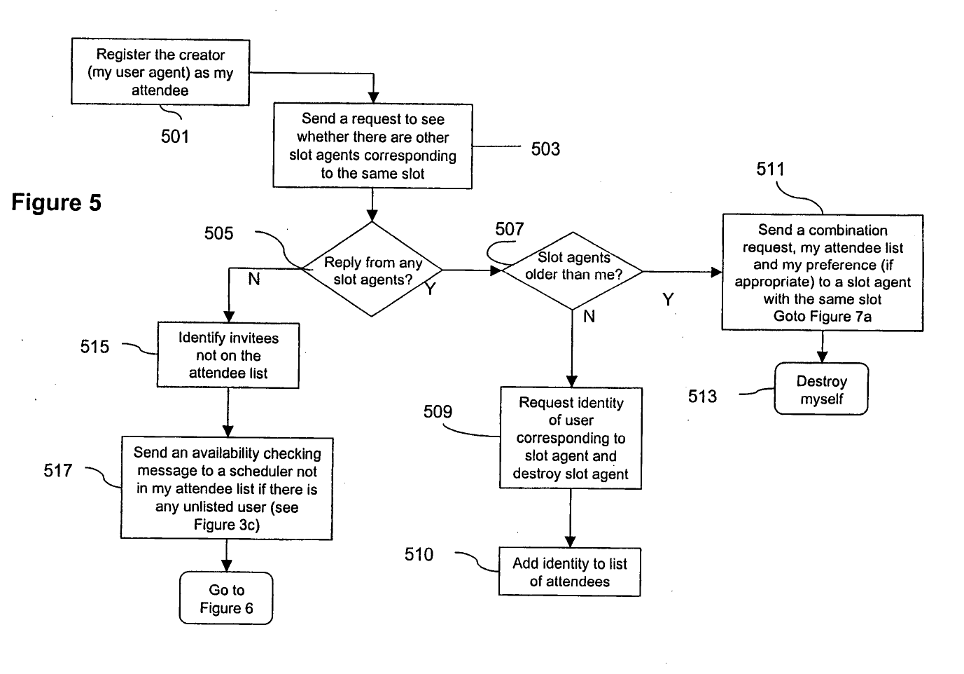

FIG. 5 is a flow diagram showing steps carried out by the slot agents created according to FIG. 3a;

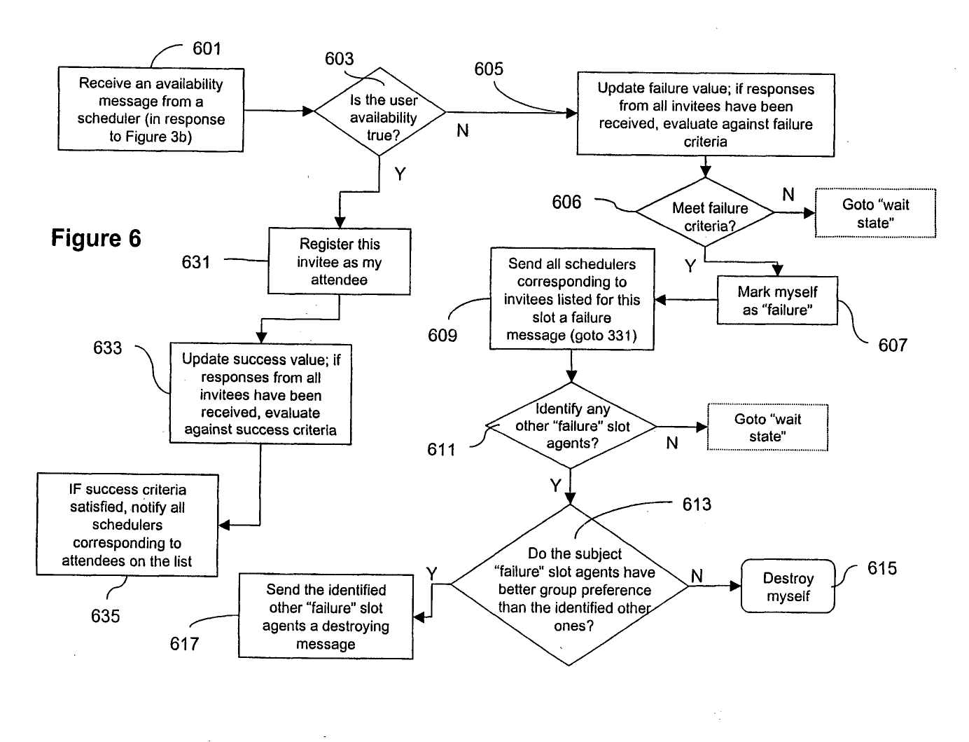

FIG. 6 is a flow diagram showing further steps carried out by the slot agents created according to FIG. 3a;

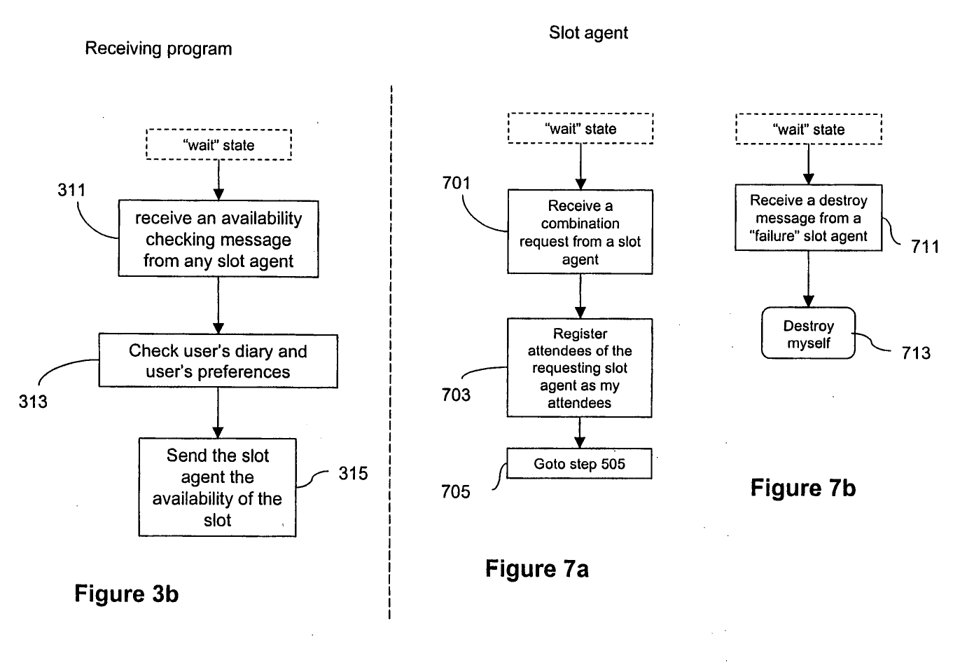

FIG. 7a is a flow diagram showing actions carried out by the apparatus of FIG. 2 in response to receipt of a combination message from a slot agent created according to FIG. 3a;

FIG. 7b is a flow diagram showing actions carried out by the apparatus of FIG. 2 in response to receipt of a failure message from a slot agent created according to FIG. 3a; and

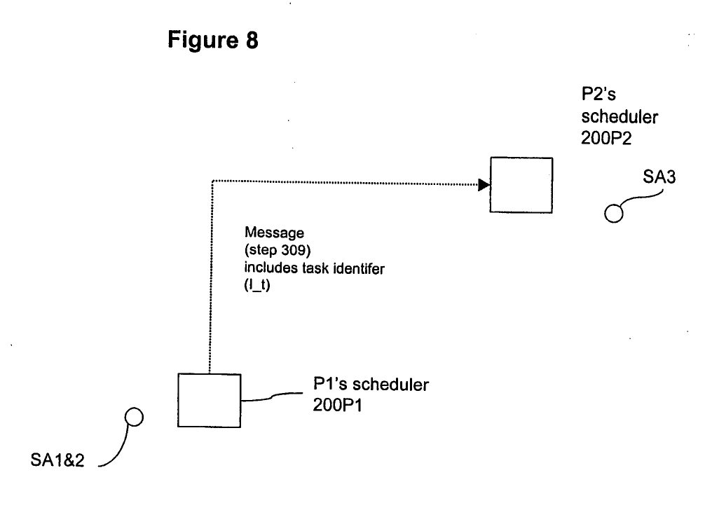

FIG. 8 is a schematic flow diagram showing slot agents corresponding to a second embodiment that have been created in accordance with the steps of FIG. 3a.

### OVERVIEW

FIG. 1 shows the physical level of the communications environment within which embodiments of the invention operate. FIG. 1 shows a plurality of terminals T1 . . . T6, where T1 and T2 each represent a local area network (LAN) server; T3, T4, T6 represent fixed clients and T5 represents a mobile terminal.

The various terminals can communicate via a number of different communications channels forming parts of different notional networks (although some or all may be commonly owned). A public switched telephone network (PSTN) N1 is interconnected with an integrated services digital network (ISDN) N2 via a gateway G1 (e.g. a local or international switching centre), and the ISDN is connected via an ISDN line L1 to terminal T3, and thence to local area network N3. A public land mobile network (PLMN) (e.g. a GSM-compatible digital cellular network) N4 is connected via a gateway G2 to the PSTN N1 and ISDN N2. A base station B1 of the PLMN provides a Pico cell in the vicinity of terminal T5, and a base station B2 provides a cell within the same general area. Thus, the networks N1-N4 are capable of delivering data at different rates to the various terminals T1-T6: low speed data via the PLMN N4, higher speed data via the PSTN N1, and yet higher speed data via the ISDN N2 or LAN N3.

Although the server terminals T1, T2 are shown connected to the same LAN N3, they could be connected to different LANs, e.g. to a server within a company Intranet, or they could be Internet web servers. Similarly, although the fixed terminals T3, T4, are shown connected to the same LAN N3, they could be connected to different local area networks.

Each of the terminals T3 . . . T6 includes a processor that is operable to run conventional diary management applications, such as Microsoft Outlook™. In addition, the terminals include a scheduler according to an embodiment of the invention. The scheduler and operation thereof are described in detail below, but, in overview, when a user proposes a meeting, for which there are a plurality of attendees, the proposing user enters one or more preferred dates for the meeting and the duration thereof, whereupon the scheduler of the proposing user creates a plurality of slot agents, each representing a time that is convenient for the proposer (taking account of, for example, other events in the proposer's diary). The scheduler also sends a message to the schedulers of the attendees, detailing the one or more preferred dates for the meeting. Upon receiving such a message, the schedulers of the invitees similarly create slot agents, each representing a time slot that is convenient to a respective invitee, on the preferred dates. The slot agents then communicate with one another, independently of their respective schedulers, and identify other slot agents (i.e. associated with potential attendees) corresponding to the same time slot.

Thus for a particular slot, the number of invitees that can attend the meeting at that time is registered. When a plurality of slots is so identified, the number of attendees registered therewith can be compared in order to select a “preferred” slot for the meeting. As stated above (in the introductory section) an advantage of identifying a plurality of slots is that if the “first choice” slot subsequently becomes unavailable, one of the other slots can be selected, without needing to repeat the whole scheduling process.

The scheduler can plug into the conventional diary management application DA, as shown in FIG. 2; in fact the user can specify the initial “preferred dates” via a diary management interface such as that provided by Outlook™, and the scheduler can consult the diary that is maintained by Outlook™ when creating the proposer's slot agents.

An embodiment of the invention will now be described in more detail with reference to FIGS. 2 to 7b. FIG. 2 is a block diagram showing elements of the first embodiment, generally referred to as scheduler 200, while FIG. 3a is a flow diagram showing steps carried out by scheduler 200 when creating slot agents on behalf of the proposer and when responding to input from slot agents. FIG. 4 is a schematic diagram showing slot agents created by a plurality of schedulers, according to the invention, and FIG. 5 is a flow diagram showing interaction between slot agents when trying to identify compatible slots. FIG. 6 is a flow diagram showing steps carried out by a slot agent when contacting schedulers directly and FIGS. 3b, 7a and 7b are flow diagrams showing other aspects of communication between slot agents. In the flow diagrams, the direction of arrows indicates the order in which steps are performed.

Turning firstly to FIG. 2, the scheduler 200 runs on a terminal, such as one of those shown in FIG. 1 (terminal T3 in FIG. 2). In addition to the conventional diary management application described above, the terminal T3 comprises a central processing unit (CPU) 201, a memory unit 203, an input/output device 205 for connecting the terminal T1 to the network N1, storage 207, and a suite of operating system programs 209, which control and co-ordinate low level operation of the terminal T3. Such a configuration is well known in the art.

The scheduler 200 comprises at least some of programs 210, 211, 213, 215. These programs are stored on storage 207 and are processable by the CPU 201. The programs include a diary interface program 210, an agent creating program 211, a schedule checking program 213 and a receiving program 215 configured to receive input from agents created by this, or another, scheduler 200. A library 217 of objects is also provided, for use in creating slot agents; this library 217 may be stored on a server terminal such as T1 or T2 shown in FIG. 2 and accessible by the schedulers 200 running on any of the terminals T3 . . . T7. The diary interface 210 is arranged to receive input from whichever diary application DA is running on the terminal T3; in this example, the application is Outlook™, so that the user can activate the diary interface 210 via a dialogue box, a menu item or a button that has been customised to inter-operate with Outlook™.

Each terminal T4, T5, T6 and T7 that is used by a user who wants meetings to be scheduled in accordance with the invention is equipped with a scheduler 200.

Turning now to FIGS. 3a and 4, the steps carried out when the scheduler 200 is used to propose a meeting are described. The scheduler of a proposing user U1 will be referred to as scheduler 200a. At step 301, the diary interface 210 receives input from the diary application DA. This input comprises duration d_m of the meeting to be scheduled, preferred days on which the meeting takes place, and a list of invitees. Assume for illustrative purposes that the user has specified 3 days—days 1, 2 and 3—and two invitees, U2 and U3. The diary interface 210 passes the input to the schedule checking program 213, which accesses 303 the proposing user's (U1) schedule (maintained by the diary application DA, but accessible independently thereof) to identify times on days 1, 2 and 3 when there are free blocks of time of duration d_m.

In the event that the schedule checking program 213 identifies one or more such free blocks, the agent creating program 211 creates 305 one or more slot agents corresponding to the identified blocks (so-called “slots”). This is described in more detail below. In the event that the schedule checking program 213 cannot identify any free blocks on those dates, the schedule checking program 213 sends 307 a failure message to the diary application DA, which invokes a dialogue box (or similar) telling the user U1 that he has no free time on his preferred days.

Assuming that the schedule checking program 213 can identify one or more blocks of time on the user's preferred days, the agent creating program 211 proceeds to create a slot agent for each available block. Assume for the purposes of the current example that three slot agents are created, SA1, SA2, SA3 (shown in FIG. 4).

A slot agent is conveniently created, using object-oriented programming techniques, as an object. The functionality of the object is dependent on the methods (or functions) that are called in respect of the object. Thus the agent creating program 211 instantiates a slot agent SA as an object, and, depending on the actions to be undertaken by the slot agent SA, accesses the library 217 and assigns one or more methods to the object. The methods stored in the library 217 are defined, by function, in the Appendix. Step 305 includes each slot agent SA storing, locally, its time of creation, the identity of its corresponding user, and identifiers l_m, t_s, which are representative respectively of the meeting and the slot time for which the SA has been created. The slot agents created by the proposer's scheduler 200a also includes a list of all of the invitees U1, U2 and U3.

Having created its own slot agents SA1, SA2, SA3, the schedule checking program 213 of the proposing scheduler 200a sends 309 a message to schedulers of the other invited attendees 200b, 200c, the message including details of days 1, 2 and 3, the duration of the meeting d_m and the identity of the meeting l_m. When an invited scheduler 200b receives such a message, the message is passed, by the diary application DA corresponding thereto, to its scheduling checking program 213, which proceeds to carry out steps 303, and 305, thereby creating three slot agents SA4, SA5, SA6. Similarly, invited scheduler 200c receives the message sent at step 309 and creates two slot agents SA7, SA8.

As an alternative, the proposing scheduler 200a sends the inviting message before creating its own slot agents, so that step 309 is performed immediately after step 303. This means that the slot agents corresponding to the invited schedulers 200b, 200c may have an earlier creation time than those of the proposing scheduler 200a.

As an additional alternative, each scheduler 200a, 200b, 200c may, instead of creating a plurality of slot agents, create one slot agent only. This alternative is preferable if there is a privacy constraint on the scheduling; however, if the objective is to schedule an event in a short timescale, a plurality of slot agents SA should be created. This is described by means of a second example, set out later in the description.

The actions of a slot agent will now be described with reference to FIG. 5. At step 501, the slot agent SA1 registers the creator of the slot agent SA1 as an attendee of the meeting. Such registration involves storing the details of the attendee on an attendee list, which is stored and managed by the slot agent SA1.

The slot agent SA1 then broadcasts 503 a request message, identifying the meeting to which the slot agent SA1 corresponds (identifier l_m) and the time of the slot t_s. Since the request message is a broadcast message, all slot agents SA in existence receive the message, and those to which the parameters l_m, t_s relate send 505 a reply message. Similarly, the other slot agents SA2, SA3, SA4, SA5, SA6, SA7, SA8 broadcast request messages, identifying the slot to which they relate.

It will be understood that each slot agent SAn can operate autonomously and in parallel with the actions of all other slot agents. However, for the purposes of illustration, the progress in respect of slot agent SA1 will be described (the parallel nature of the process is illustrated by the example given at the end of the description of FIGS. 2-7b). Assuming (again for illustrative purposes) that slot agent SA4 sends a reply message, slot agent SA1 receives the reply, and compares 507 the time of creation of itself (SA1) with that of the replying slot agent SA4. If slot agent SA1 is older than the replying slot agent SA4, slot agent SA1 sends 509 a message to the replying slot agent SA4, requesting the identity of the user corresponding thereto and instructing the slot agent SA4 to destroy itself. The requested identity U2, when received, is added 510 to the list of attendees created at step 501. In the event that the replying slot agent SA4 is older than slot agent SA1, slot agent SA1 sends 511 its stored list of attendees to the replying slot agent SA4, and destroys 513 itself. The former case applies when the proposing scheduler 200a creates its slot agents SA1 . . . SA3 first, whereas the latter case applies when an invited scheduler 200b, 200c creates its slot agents SA4 . . . SA7 first (since time of creation determines relative ages of the slot agents). These steps (509, 510 or 511, 513, as appropriate) are repeated in respect of each slot agent SA that replies to the broadcast message sent at step 503.

Assuming that the slot agent SA1 corresponding to the proposing scheduler 200a is the oldest, then after a specified time has elapsed, the slot agent SA1 identifies 515 those invitees that are not on the list of attendees (the list that has been populated at steps 501 and 510). The slot agent SA1 sends 517 an availability request to the schedulers of the invitees identified at step 515, which in the current example is the scheduler of invitee U3. The availability request comprises data identifying the time of the slot corresponding to slot agent SA1.

Referring to FIG. 3b, when such an availability request is received 311, the receiving program 215 of that scheduler 200c checks 313 the user's diary to see whether the user U3 is in fact available during at time of the slot, and, if he is free, whether he has a particular preference for keeping that slot free.

A user may be free during a slot for which no slot agent has been created because the schedule checking program 213 may have received some constraint information from the diary application DA, via the diary interface 210, detailing a user's preference to keep that slot clear. In such a situation, the schedule checking program 213 will not pass information relating to that slot to the agent creating program 215. Thus when the receiving program 215 receives an availability message, such as that sent at step 517, it will firstly simply check whether its user (here U3) is in fact available or not.

A user's availability can be identified from review of the user's diary, and can thus be obtained automatically; however, identifying the user's preference may involve engaging in dialogue with the user. Accordingly, step 313 may involve the receiving program 215 sending a message, via the diary interface 210, to the diary application DA, causing the application DA to ask the user for some feedback in respect of the slot.

Having ascertained the availability and preference of user U3, the receiving program 215 corresponding thereto sends 315 an availability message to whichever slot agent (here SA1) sent the availability request at step 517. The availability message includes a preference value, indicative of the preference of the user to attend the meeting at the slot time.

Turning to FIG. 6, at step 601, the slot agent SA1 receives the availability message sent at step 317, and, if the message indicates that user U3 is not free (evaluated at step 603), the slot agent SA1 uses the user's preference for attending the meeting during that slot to evaluate 605 a group preference therefor (the user U3 may, for example, have had an appointment in his diary during the slot in question, but, in response to the preference request (step 313), the user may have indicated that he could not change that appointment, thereby specifying a low preference for attending meeting l_m).

The group preference indicates a collective preference for attending the meeting during that slot. Assuming that “most preferred” is indicated by a value of 3, “least preferred” is indicated by a value of 1 and “not available” is indicated by a value of 0, then, in the event that two out of three invitees could attend the meeting during a slot, with preference values of, respectively, 2 and 1, the group preference would be 1/3. In the event that three out of three invitees could attend the meeting during a slot, with preference values of, respectively, 3, 1, 3, the group preference would be 7/9.

The group preference evaluated at step 605 is then evaluated 606 against a failure criterion (or criteria). This can involve, e.g., comparing the group preference with a specified value. Alternatively, the failure criterion can be dependent on one or a specified percentage (e.g. 20%) of users being unavailable for a slot; and/or one or more very important users being unable to attend (relative importance of the invitees could be input together with the user's schedule at step 301, and this information will be passed to whichever slot agent SA is remains at step 510 or 511 (in this example SA1)). In the event that the criterion is not satisfied, the slot agent SA1 marks itself 607 as a “failure”, and sends 609 all schedulers 200b, 200c of the invitees a failure message (whether or not the invitees have been registered an attendee on the list populated at steps 501 and 510). This means that this slot is marked as “rejected”, and will not be selected in the future.

Although some of the invitees may not be available during the slot corresponding to this slot agent SA1, it may be that more invitees can attend at the time of this slot than at the time of other slots. Accordingly the failure message sent at step 609 includes the group preference.

As a consequence of step 609, it can be seen that all schedulers corresponding to invitees on the attendee list (in this example, scheduler 200b) store group preferences corresponding to slots. This means that slot agents that are subsequently created by the scheduler 200b can compare their group preferences with the group preference corresponding to the slot associated with slot agent SA4, even though slot agent SA4 has actually been destroyed (at step 509). Similarly, in the present example, it is assumed that scheduler 200a stores details of group preferences corresponding to slots other than that associated with slot agent SA1, and, irrespective of the scheduler association of those slot agents, the slot agent SA1 can compare the group preferences evaluated at step 609 with that/those stored by the scheduler 200a.

Once the slot agent SA1 has sent out the failure message (step 609), it identifies 611 whether there are any other “failure” slots. This involves broadcasting a message for any slot agents in existence relating to meeting l_m, requesting the group preference. For each reply that it receives, it compares 613 the group preference for the subject slot with that corresponding to other slots; in the event that the group preference corresponding to SA1 is less than the group preference of other slots that the scheduler (here 200a) corresponding to SA1 knows about, the slot agent SA1 destroys 615 itself. If, however, the group preference is greater than that of other such slots, the slot agent SA1 sends 617 a message to the slot agent(s) from which it received a message, instructing the slot agents to destroy themselves.

Since the process of comparing group preference and preference threshold information to select a most “preferred” slot agent is performed by the slot agents themselves, it is not essential for the schedulers to store this information. However, it is preferable for at least one scheduler (possibly the proposer's scheduler, here 200a) to store the group preference information so that, in the event that the most preferred slot subsequently becomes unavailable, the “next best” slot can be used.

Turning to FIG. 7b, when a slot agent receives 711 such a destroy message, it destroys itself 713.

Turning back to step 603 of FIG. 6, in the event that the availability message received at step 601 identifies the user U3 to be free, user U3 is added 631 to the list of attendees, and the slot agent SA1 updates 633 the group preference corresponding to this slot. The slot agent SA1 then evaluates the group preference against a success criterion; this can involve comparing the group preference with a required number of attendees (e.g. “all invitees”) or comparing the group preference with that corresponding to other slots (it will be appreciated that, simply because one of the availability messages indicates the user to be available, others thereof may be unavailable, so that the overall group preference may be less than 1.0). Comparison of the group preference with either the so-called “failure” criterion or with the “success” criterion will depend on whether the last availability message was received from a scheduler whose user is actually available or not (since the branching at step 603 is dependent thereon).

In the event that the success criterion is satisfied, the slot agent SA1 sends 635 a message to all attendees on the list, asking them to reserve that slot for meeting l_m. Turning now to FIG. 7a, if, at step 507, one of the other slot agents SA4 . . . SA8 had been older than slot agent SA1 of the proposer's scheduler 200a, that older slot agent (assume here that it is SA4) would have received 701 a combination request. Such a combination request includes the list of attendees stored by SA1 up until its destruction (step 513). This slot agent SA4 adds 703 the items on the list to its own list of attendees, and proceeds 705 to carry out the method steps described above, from step 505 onwards.

The sending of combination requests could depend on other criteria besides time of creation of slot agent—such as size of attendee list, so that, when two slot agents are communicating, the size of attendee list is passed between them. Whichever slot agent has the largest attendee list will then receive (step 701) a combination request from the other slot agent.

Returning to FIG. 3a, the failure messages sent at step 609 are received 331 and stored by the proposer's scheduler 200a, and the slots corresponding to the failure messages are marked 333 as “rejected” in the user's diary. In this example this involves sending a message, via the diary interface 210, to the diary application DA, which causes an entry to be made in the proposing user's diary.

In the event that the scheduler 200a has received data in respect of all slot agents SA1, SA2, SA3 created at step 305, the schedule checking program 213 checks to see (step 335) whether or not all possible slot agents have been created. Recall that the data may not be received from these slot agents—if, for example, these slot agents were combined with other slot agents and then destroyed, because of the relative difference in their creation times (see steps 507, 509, 511), then the data would be received from the other, older, slot agents.

If the scheduler 200a has not received data in respect of all slot agents created at step 305, it stores 336 the data received at step 331 and waits for further data.

If data has been received in respect of all slot agents created by the proposing user's scheduler 200a (here SA1, SA2 and SA3), then at step 337, the group preferences corresponding to the failure messages received at step 331 are compared with a group preference threshold. In the event that none of the group preferences exceeds the threshold, the proposing user is requested, by a message passed via the diary interface 210, to relax the meeting constraints. This may require, for example, the proposing user to specify different dates for the meeting.

However, if there are still some slots for which agents have not been created (as may occur if, as discussed earlier, only one is created at step 305), that would satisfy the proposing user's original constraints, the agent creating program 215 creates new slot agents, repeating steps 305 onwards in respect thereof.

Thus at the end of the slot agent creation and negotiation process, the scheduler 200a corresponding to the proposing user will have a record of group preferences relating to each of the slots for which it created slot agents, and, in the event that the success criterion in respect of one of the slots has been satisfied, the attendees of the meeting will have reserved the slot for this meeting. This enables the scheduler 200a to identify, from the slots that did not satisfy the success criterion, those slots that best satisfy the proposer's constraints (e.g. maximises the number of attendees, or that the most important attendees can make). This is advantageous since, at a later date, one of the attendees may have to attend an event, which overlaps with this slot, and for which the priority is higher than for attending this meeting. In this situation, the scheduler 200a of the proposing user U1 re-evaluates the preference for this slot (taking into account the effect to the non-attendance of this user) and re-assesses the relative preferences of all of the slots. Thus rather than having to start the negotiating process again, the scheduler 200a can suggest one of the other slots as a replacement.

The slots that are identified by the scheduler 200a are passed to the diary application DA, which marks the meeting into the user's diary.

In the event that the proposing user U1 wants to stop the scheduling process, the scheduler 200a sends a “stop” message (not shown) to all invitees (here U2 and U3), which causes their schedulers 200b, 200c to delete whichever slot agents are in existence at that time.

The proposing user could be someone who is not going to attend the meeting himself; for example, the proposing user could be an administrative officer whose task is to organise meetings. In this situation the preferences of the proposing user should not be taken into account, so the failure criteria that are used to assess the suitability of a slot will ignore the ability, or lack thereof, of the slot agents created by the proposing scheduler, to attend a meeting. One solution is for the proposing scheduler to create slot agents corresponding to every slot, so that the selection of preferred slot agents is totally unbiased by the proposer; such a proposing scheduler would thus be a “dummy” scheduler. In addition, step 309 could be carried out before 305, so that the slot agents of the dummy scheduler would always be combined with a slot agent of a “real” attendee; the details that accompany the combination request (step 511) would then include the status of this invitee as “dummy” and handled accordingly.

An example is now described where one slot agent at a time is created by a scheduler. We assume that Host A wants to organise a one-hour meeting with invitees B and C at some time between 9 am-12 pm. The success criterion is that all of the invitees attend the meeting, and the failure criterion is that a single invitee is unable to attend the meeting. The diary entries and preferences of A, B and C for three slots, 9-10; 10-11 and 11-12, are (we assume that these preferences have been captured by the schedule checking program 213):

| | 9-10 am | 10-11 am | 11 am-12 noon |
|---|---|---|---|
| A | 3 | 2 | 1 |
| B | 0 | 3 | 2 |
| C | 0 | 2 | 3 |

(0 means a user is unavailable; 3 means most favourite slot, 2 means medium favorite slot and 1 means least favourite slot).

SchedulerA informs SchedulerB and SchedulerC of the meeting information (step 307), whereupon SchedulerB, SchedulerC and SchedulerA each propose one slot (step 303). SchedulerA proposes the 9-10 am slot because it has the highest preference (creating slot agent A(9-10)), while SchedulerB proposes 10-11 am and SchedulerC proposes 11 am-12 noon (creating slot agent B(10-11) and slot agent C(11-12) respectively). In this example each scheduler SchedulerA, SchedulerB, SchedulerC only creates one slot because their respective users do not want any unnecessary availability information to be advertised.

At step 503, slot agent A(9-10) sends a request to see whether there are other slot agents corresponding to its slot. Similarly, slot agents B(10-11) and C(11-12) send requests to see whether there are slot agents corresponding to their slots.

In this example, none of the other existing slot agents correspond to any of these slots (since they are mutually exclusive).

Starting with slot agent A(9-10), at step 515, the slot agent A(9-10) identifies invitees that are not on the attendee list (here B and C) and sends (step 517) an availability checking message to schedulerB, which returns a preference of 0. Slot agent A(9-10) then updates the failure value for this slot; since the failure criterion is that no invitees are allowed to decline attending the meeting, slot agent A(9-10) marks itself as a failure (step 607). Since slot agent A(9-10) has not listed any attendees other than A, the slot agent A(9-10) does not need to send out a failure message (609). Thus the slot agent A(9-10) destroys itself (step 615), and SchedulerA creates a new slot agent, slot agent A(10-11) corresponding to its next preferred slot, 10-11.

At the same time, the slot agent B(10-11) identifies invitees that are not on the attendee list (here A and C) and sends (step 517) an availability checking message to schedulerC, which returns an available reply, with preference of 2. Slot agent B(10-11) registers (step 631) invitee C as an attendee and updates the success value for this slot (step 633).

Shortly thereafter, slot agent A(10-11) sends a request (503) for other slot agents corresponding thereto, and receives a reply from slot agent B(10-11); since slot agent B(10-11) is older than slot agent A(10-11), slot agent A(10-11) combines (step 511) with slot agent B(10-11), adding itself as an attendee of the meeting, with preference 2, and then deletes itself (step 513). Since all of the preferences have now been received by slot agent B(10-11), it calculates the success value (step 633), which in this case is 3+2+2=7, and notifies all of the schedulers (schedulerA, schedulerB, schedulerC) to reserve this slot (step 635).

At the same time, slot agent C(11-12) proceeds as described in respect of slot agent B(10-11), and, since all of the invitees are available, slot agent C(11-12) does not need to carry out steps 605-615, and instead calculates the success value (step 633) corresponding thereto, which in this case is 1+2+3=6. Slot agent C(11-12) then notifies all of the schedulers (schedulerA, schedulerB, schedulerC) to reserve this slot (step 635). This means that there are two possible slots in which the meeting could be scheduled, and this is recorded by the schedulers of the meeting attendees A, B, C.

### Other Embodiments

The embodiment above is in the domain of meeting scheduling. However, the invention could be applied to many other domains where cooperation between a plurality of resources is an issue. Other application areas include scheduling shift work involving a plurality of workers; and scheduling processor activity, where the processors are arranged to control devices and/or other processors.

In particular, the invention can be applied to the problem of balancing work between several processors, where the objective(s) involve(s) minimising the cost of running the tasks and/or maximising performance. For such a problem, an embodiment involves each processor creating a slot agent, which represents processing capability of its respective processor. The slot agents negotiate, in the manner described in the first and second examples of the meeting scheduler embodiment, but in this embodiment the negotiation is not about identifying a slot time that all resources can agree on, negotiation is instead about identifying a distribution of tasks over the resources such that the objectives of minimising costs and/or maximising performance etc. are achieved. This embodiment is best described with reference to an example:

We assume that there is a piece of work involving 3 tasks, or jobs (J1, J2, and J3) that needs to be performed as quickly as possible, and that there are 2 processors P1, P2 available to carry out the work. Referring to FIGS. 8 and 3a, resource details include details of the task requirements and resource capabilities; accordingly, at step 301 scheduler 200P1, 200P2 of each resource receives data specifying that processing of J1 requires memory JM1, processing of J2 requires memory JM2, and processing of Job3 requires memory JM3. Scheduler 200P1 knows that the processing capability of P1 is PM1 and scheduler 200P2 knows that the processing capability of P2 is PM2.

Thus at step 303 schedulers 200P1, 200P2 evaluate whether or not they have sufficient processing capability for any of the jobs J1, J2, J3, and if they do, they create slot agents corresponding thereto.

In a first example, we assume that scheduler 200P1 determines (step 303) that it has sufficient processing capability to process J1 and J2, and accordingly creates (step 305) a slot agent SAJ1&2 for these jobs, while scheduler 200P2 determines that it has sufficient processing capability to process job J3 and creates a slot agent SA3 corresponding thereto. Each slot agent stores an identifier l_t indicative of the task to which the jobs J1, J2, J3 relate.

Slot agent SA1&2 then sends out a message (step 503) to see whether there are any other slot agents corresponding to the same task. In this example, slot agent SA1&2 will receive a reply from slot agent SA3, and the slot agents will be combined (steps 507, 509, 511, 513). We assume for this example that slot agent SA1&2 was created first, so that slot agent SA3 is destroyed, having sent details of the job that it has selected to slot agent SA1&2 (steps 509, 510).

The slot agent SA1&2 then evaluates the distribution of jobs between processors P1 and P2, and, in the event that the distribution satisfies a specified criterion (which can include, for example, cost of allocating jobs to these processors), the slot agent SA1&2 notifies the respective processors that they should perform the jobs “allocated” thereto at step 305.

In a second example, we assume that scheduler 200P1 determines (step 303) that it has sufficient processing capability to process J1 and J2, and accordingly creates (step 305) a slot agent SAJ1&2 for these jobs, while scheduler 200P2 determines that it has sufficient processing capability to process job J2 and creates a slot agent SA2 corresponding thereto.

Slot agent SA1&2 then sends out a message (step 503) to see whether there are any other slot agents corresponding to the same task. In this second example, slot agent SA1&2 will receive a reply from slot agent SA2, and the slot agents will be combined (steps 507, 509, 511, 513).

The slot agent SA1&2 then evaluates the distribution of jobs between processors P1 and P2, and notes that job J3 has not been allocated to either processor, and that one of the jobs (J2) has been selected by both processors.

These two slot agents then compare resource utilization of their respective processors to identify the most efficient allocation of job J2. Imagine, for example, the situation where, if P1 executes J1 and J2, P1 will have 20% unused memory, and the situation where, if P2 executes J2, it will have 50% unused memory. In this example, it is better for P1 to process J2 because its memory will be used more efficiently. Accordingly, for such a situation, SA1&2 and SA2 would be combined and SA2 would be destroyed, while a “rejection” message in respect of J2 would be sent to P2.

At this point, one job is not on the “selected jobs” list (populated by slot agent SA1&2 at step 510), so that, at step 515, the slot agent SA1&2 identifies which of the jobs is missing (J3), and sends an availability message to both of the schedulers 200P1, 200P2 (step 517) in respect of this job J3. Turning to FIG. 6, in the event that scheduler 200P2 returns a message indicating that it can perform job J3, slot agent SA1&2 registers this job as “selected” (step 631), and evaluates the success criteria (all jobs to be completed in minimum time). Clearly the current distribution of jobs satisfies criterion “all jobs to be completed”, so that this is a possible distribution of jobs.

However, if the scheduler 200P2 returns a message indicating that it cannot perform job J3, and scheduler 200P2 returns a message indicating that it cannot perform J3 on top of already selected jobs J1 and J2, the failure value is updated (number of jobs uncompleted). If the failure value satisfies the failure criteria (any jobs unallocated to a processor), the task is marked as a failure (steps 606, 607), and a failure message is sent to the relevant schedulers.

This causes the schedulers 200P1, 200P2 to create new slot agents (steps 333, 335, 305). Since we know that processor P2 can carry out job J2, but it cannot carry out job J3, scheduler 200P1 will not create a slot agent in respect of job J2 (step 305). If the processing capabilities of processor P1 are limited such that it cannot carry out both J1 and J3, the next attempted round of scheduling will also result in failure, and ultimately the process will arrive at step 337.

The embodiments above describe combining slot agents in accordance with their respective times of creation (steps 507, 509, 511). Other criteria are possible, including selecting a direction of combination at random or selecting a direction of combination in accordance with the identity of slot agents.

Appendix

Slot Agent Object Methods (Inclusive List)

After a slot agent has been created,
find a slot agent which has the same meeting id
compare slots with the other slot agents
send user information in the agreed user list to the other slot agent if the slot is same; and
destroy the slot agent after sending
record user information sent from a slot agent with the same slot
send a user a query to check his availability
add the user into attendee list if receiving a response from a user about his free availability
examine success criteria; report to the proposing scheduler the success if success criteria are met
examine failure criteria; report the failure to every scheduler if failure criteria are met
identify a failed slot agent in the system (if there is any)
compare the success values with the other failed slot agent
destroy the failed slot agent having a lower success value

1. A method of scheduling an event, the event involving a plurality of resources, the method comprising performing a process in respect of each resource, the process comprising identifying a slot time corresponding to a time at which the resource is available; and creating a software component corresponding to the identified slot time, wherein the software component comprises communicating means arranged to communicate with other like software components, and storage arranged to store data in respect of the resource corresponding to the software component and data in respect of the identified slot time; and wherein each software component so created communicates with another like software component in order to identify a time for the event that satisfies a predetermined criterion.

2. A method according to claim 1, in which identifying a time for the event includes, for each slot time
accessing the slot time data stored by the software components in order to identify software components corresponding thereto;
using stored data in respect of the resources corresponding to the identified software components to evaluate the suitability of the slot time for the event; and
selecting a time for the event in accordance with the evaluated suitabilities.

3. A method according to claim 1, in which the process includes accessing a schedule associated with the said resource and retrieving data indicative of the availability of the resource.

4. A method according to claim 1, in which, for each slot time, the method includes storing data in respect of the resources corresponding to the identified software components.

5. A method according to claim 1, in which, for each slot time, the method includes comparing the data in respect of the resources corresponding to the identified software components with data in respect of the plurality of resources involved in the event, so as to identify those resources for which there is no software component,
sending a message to the identified resource, the message including a request for preference information in respect of the slot time,
receiving said preference information and
if the preference information indicates that the resource is available at that slot time, updating the data in respect of the resources corresponding to the identified software components.

6. A method according to claim 2, in which the step of evaluating the suitability of a slot time comprises calculating the number of resources corresponding to the identified software components corresponding to the slot time and comparing the calculated number with a specified criterion.

7. A method according to claim 5, in which the step of evaluating the suitability of a slot time comprises comparing the data in respect of the resources corresponding to the identified software components with data in respect of one or more resources whose involvement with the event is essential.

8. A method according to claim 6, in which, if the preference information indicates that the resource is unavailable at that slot time, the method includes incorporating this preference information in the suitability evaluation.

9. A method according to claim 2, including notifying the resources corresponding to the identified software components corresponding to the slot time of the selected slot time.

10. A method according to claim 9, in which, in the event that the selected time becomes unavailable, the method includes sending a message indicative of a change in status of the selected slot time to the notified resources, and reviewing the stored suitability to select a replacement slot time.

11. A method according to claim 1, in which the process includes storing a time of creation of the software component corresponding thereto.

12. A method according to claim 11, in which said step of identifying a slot time corresponding to a time at which the resource is available includes
identifying which of the identified software components was created first;
adding data in respect of resources corresponding to the other software components to the storage of the identified first created software component and
deleting the other software components.

13. A method according to claim 1, including selecting an initiating resource, the initiating resource being one of the plurality, performing the process in respect of the initiating resource, sending event details to the others of the plurality of resources, and performing the process in respect of the others of the plurality of resources.

14. A software component for use in selecting a time for an event, wherein the event involves a plurality of resources, the software component comprising
communicating means arranged to communicate with other lil<e software components and
storage arranged to store data in respect of a resource corresponding to the software component, the data including a time at which the resource is available for the event,
the software component being arranged, in use, to communicate with other software components to identify those software components storing data relating to the same time, and, for any software components so identified, the software component is arranged to store data relating to the identified software components in the storage and evaluate the suitability of the time for the event.

15. A software component according to claim 14, wherein the storage includes data identifying a time of creation of the software component, the software component further being operable to access times of creation corresponding to the identified software components, and, if the time of creation corresponding to the software component is later than that corresponding to any one of the identified software components, the software component is operable to destroy itself.

16. A diary system for use in scheduling an event on behalf of a user, comprising
schedule querying means arranged to identify one or more times at which the user is available for the event,
software component creating means arranged to create a software component according to claim 14, wherein the data stored in the storage thereof includes one of the identified times, and
schedule updating means arranged to receive, from the, or another such software component, data indicative of a time at which the event is to be scheduled, and to update the schedule in accordance therewith.

17. A diary system according to claim 16, wherein, in the event that the software component receives data indicative of a failed scheduling attempt, the software component creating means is arranged to create a further software component corresponding to one of the other times at which the user is available for the event.

18. A method of selecting a time for an event, the event involving a plurality of resources, the method comprising the steps of
performing a process in respect of each resource, the process comprising
identifying a slot time corresponding to a time at which the resource is available;
creating a software component corresponding to the identified slot, the software component comprising communicating means arranged to communicate with other like software components and storage arranged to store data in respect of the resource corresponding to the software component and data in respect of the identified slot time; for each slot time:
accessing the slot time data stored by the software components in order to identify software components corresponding thereto;
using stored data in respect of the resources corresponding to the identified software components to evaluate the suitability of the slot time for the event; and
selecting a time for the event in accordance with the evaluated suitabilities.

19. A method of distributing a plurality of tasks between a plurality of resources, comprising
performing a process in respect of each resource, the process comprising
identifying a processing capability of the resource; and
creating a software component corresponding to the identified capability, wherein the software component comprises communicating means arranged to communicate with other like software components and storage arranged to store data in respect of the resource corresponding to the software component, the data including the identified capability;
wherein each software component so created is operable to communicate with another like software component in order to identify distribution of tasks that satisfies a predetermined criterion.

20. A method according to claim 19, in which the process includes selecting at least one of the plurality of tasks in accordance with the identified processing capability and storing the same in the storage of the created software component.

21. A method according to claim 20, in which said predetermined criterion includes a condition that each of the plurality of tasks has been selected by at least one software component.

22. A method according to claim 20, in which said predetermined criterion includes a cost associated with the selection, so that the step of identifying distribution of tasks include evaluating the cost associated therewith.

23. A method according to claim 20, in which, in the event that one of the plurality of tasks has been selected by more than one software component, the method includes comparing utilisation of processing capabilities between resources, and allocating said one task to whichever resource has the most efficient processing capability utilisation.
